(19) United States
(12) Patent Application Publication
(10) Pub. No.: US 2012/0244814 A1
(43) Pub. Date: Sep. 27, 2012

(54) HANDSFREE APPARATUS

(75) Inventor: Takafumi Okayasu, Obu-city (JP)

(73) Assignee: DENSO CORPORATION, Kariya-city (JP)

(21) Appl. No.: 13/424,487

(22) Filed: Mar. 20, 2012

(30) Foreign Application Priority Data
Mar. 23, 2011 (JP) 2011-64363

(51) Int. Cl. H04B 7/26; H04M 1/00

(52) U.S. Cl. 455/41.3

(57) ABSTRACT

When determining that radio waves of a WiFi link are deteriorated during a WiFi handsfree voice call, a handsfree apparatus notifies a user that the radio waves of the WiFi link are deteriorated. When the user selects a switchover from the WiFi link to a Bluetooth link, the handsfree apparatus starts a BT handsfree voice call by connecting the Bluetooth link, and then ends the WiFi handsfree voice call by disconnecting the WiFi link, which is deteriorated. Thus, a handsfree voice call between the handsfree apparatus and a partner communication apparatus can be continued without interruption.

### CROSS REFERENCE TO RELATED APPLICATION

This application is based on Japanese Patent Application No. 2011-64363 filed on Mar. 23, 2011, the disclosure of which is incorporated herein by reference.

### TECHNICAL FIELD

The present disclosure relates to a handsfree apparatus to connect a short range wireless link with a connection apparatus, thereby enabling a handsfree voice call with a call partner apparatus.

### BACKGROUND

[Patent document 1] JP 2002-223288 A

A mobile phone is used in a vehicle mainly to make a handsfree voice call. For example, the patent document 1 discloses the following. A mobile phone having Bluetooth (registered trademark, hereafter also referred to as BT) communication function is brought in a vehicle containing a handsfree apparatus with a Bluetooth communication function. Thereby, a handsfree voice call can be made by establishing a connection of a handsfree profile (HFP), which is one of the Bluetooth profiles, between the handsfree apparatus and the mobile phone.

In recent years, with development of wireless technology, there is a configuration in which several short range wireless links, which have different wireless communication specifications, can be connected selectively. It is considered that such a configuration may be applied to handsfree apparatuses so that several short range wireless links can be connected selectively. In this case, it is necessary to decide how to select and connect several short range wireless links. Otherwise, several short range wireless links may not be selected appropriately, and accordingly, a handsfree voice call may not be made appropriately.

### SUMMARY

It is an object of the present disclosure to provide a handsfree apparatus, which selects several short range wireless links suitably to enable a handsfree voice call.

To achieve the above object, according to a first aspect of the present disclosure, a handsfree apparatus includes a first wireless connection portion, a second wireless connection portion, a connection control section, and a radio wave determination section. The first wireless connection portion connects a first short range wireless link with a first connection apparatus, to enable a first handsfree voice call with a partner communication apparatus. The second wireless connection portion connects a second short range wireless link with a second connection apparatus, to enable a second handsfree voice call with the partner communication apparatus. The connection control section controls connecting and disconnecting of the first short range wireless link, and connecting and disconnecting of the second short range wireless link. The radio wave determination section determines a state of radio waves of the first short range wireless link. In cases that the radio wave determination section determines that the state of the radio waves of the first short range wireless link is moved to a first predetermined state during the first handsfree voice call being executed with the partner communication apparatus through the first short range wireless link, the connection control section is configured to start the second handsfree voice call by connecting the second short range wireless link between the second wireless connection portion and the second connection apparatus, and to then end the first handsfree voice call by disconnecting the first short range wireless link between the first wireless connection portion and the first connection apparatus.

Under such a configuration, during the first handsfree voice call between the partner communication apparatus and the handsfree apparatus through the first short range wireless link, when the state of the radio waves of the first short range wireless link is moved to the first predetermined state (i.e., a state in which phone property such as voice quality and communication speed is deteriorated), the connection control section starts the second handsfree voice call by connecting the second short range wireless link between the second wireless connection portion and the second connection apparatus before ending the first handsfree voice call by disconnecting the first short range wireless link between the first wireless connection portion and the first connection apparatus. Thus, the handsfree voice call between the handsfree apparatus and the partner communication apparatus can be continued without interruption (restart after disconnection), and a performance of the handsfree voice call can be enhanced.

According to a second aspect of the present disclosure, a handsfree apparatus includes a first wireless connection portion, a second wireless connection portion, a connection control section, and a disconnection determination section. The first wireless connection portion connects a first short range wireless link with a first connection apparatus, to enable a first handsfree voice call with a partner communication apparatus. The second wireless connection portion connects a second short range wireless link with a second connection apparatus, to enable a second handsfree voice call with the partner communication apparatus. The connection control section controls connecting and disconnecting of the first short range wireless link, and connecting and disconnecting of the second short range wireless link. The disconnection determination section determines whether the first short range wireless link having been connected is disconnected. In cases that the disconnection determination section determines that the first short range wireless link is disconnected during the first handsfree voice call being executed with the partner communication apparatus through the first short range wireless link, the connection control section is configured to start the second handsfree voice call by connecting the second short range wireless link between the second wireless connection portion and the second connection apparatus.

Under such a configuration, when the first short range wireless link is disconnected during the handsfree voice call between the handsfree apparatus and the partner communication apparatus, the handsfree voice call between the handsfree apparatus and the partner communication apparatus can be restarted by connecting the second short range wireless link between the second wireless connection portion and the second connection apparatus.

According to a third aspect of the present disclosure, a handsfree apparatus includes a first wireless connection portion, a second wireless connection portion, a connection control section, a radio wave determination section, and a connection possibility determination section. The first wireless connection portion connects a first short range wireless link with a first connection apparatus, to enable a first handsfree voice call with a partner communication apparatus. The second wireless connection portion connects a second short range wireless link with a second connection apparatus, to enable a second handsfree voice call with the partner communication apparatus. The connection control section controls connecting and disconnecting of the first short range wireless link, and connecting and disconnecting of the second short range wireless link. The radio wave determination section determines a state of radio waves of the first short range wireless link. The connection possibility determination section determines whether the first short range wireless link is enabled to be connected between the first wireless connection portion and the first connection apparatus. In cases that, during the second handsfree voice call being executed with the partner communication apparatus through the second short range wireless link, (i) the radio wave determination section determines that the state of the radio waves of the first short range wireless link is moved to a second predetermined state and (ii) the connection possibility determination section determines that the first short range wireless link is enabled to be connected between the first wireless connection portion and the first connection apparatus, the connection control section is configured to start the first handsfree voice call by connecting the first short range wireless link between the first wireless connection portion and the first connection apparatus, and to then end the second handsfree voice call by disconnecting the second short range wireless link between the second wireless connection portion and the second connection apparatus.

Under such a configuration, during the second handsfree voice call between the partner communication apparatus and the handsfree apparatus through the second short range wireless link, when (i) the state of the radio waves of the first short range wireless link is moved to the second predetermined state (i.e., a state in which phone property, for example, voice quality and communication speed is improved) and (ii) the first wireless connection portion and the first connection apparatus is connectable by connecting the first short range wireless link, the connection control section starts the first handsfree voice call through the first range wireless link before ending the first handsfree voice call through the first short range wireless link. Thus, the handsfree voice call between the handsfree apparatus and the partner communication apparatus can be continued without interruption and a performance of the handsfree voice call can be enhanced.

According to a fourth aspect of the present disclosure, a handsfree apparatus includes a first wireless connection portion, a second wireless connection portion, a connection control section, and a radio wave determination section. The first wireless connection portion connects a first short range wireless link with a first connection apparatus, to enable a first handsfree voice call with a partner communication apparatus. The first short range wireless link corresponds to a WiFi link. The second wireless connection portion connects a second short range wireless link with a second connection apparatus, to enable a second handsfree voice call with the partner communication apparatus. The second short range wireless link corresponds to a Bluetooth link. The connection control section controls connecting and disconnecting of the first short range wireless link, and connecting and disconnecting of the second short range wireless link. The radio wave determination section determines a state of radio waves of the first short range wireless link. In cases that, during the first handsfree voice call being executed with the partner communication apparatus through the WiFi link, (i) the radio wave determination section determines that the state of the radio waves of the WiFi link is moved to a first predetermined state and further (ii) the connection control section determines that a user intends to switch from the WiFi link to the Bluetooth link, the connection control section is configured to start the second handsfree voice call by connecting the Bluetooth link between the second wireless connection portion and the second connection apparatus, and to then end the first handsfree voice call by disconnecting the WiFi link between the first wireless connection portion and the first connection apparatus.

Suppose a case that during the first handsfree voice call, (i) the radio wave determination section determines that the state of the radio waves of the WiFi link is moved to the first predetermined state (a state in which phone property, for example, voice quality and communication speed is deteriorated), and further (ii) the connection control section determines that a user selects a switchover from the WiFi link to the Bluetooth link. In such a case, under the configuration of the handsfree apparatus according to the fourth aspect, the connection control section starts the second handsfree voice call through the Bluetooth link before ending the first handsfree voice call through the WiFi link, which has a higher calling quality than the Bluetooth link. Thus, the handsfree voice call through the WiFi link, which has a higher calling quality than the Bluetooth link, can be continued until the state of the radio waves of the WiFi link is moved to the first predetermined state. Further, in a case where charging fee or call rate for continuing the handsfree voice call through the WiFi link is different (i.e., less or more expensive) from charging fee or call rate for the handsfree voice call when switched from the WiFi link to the Bluetooth link, the user can make a selection in consideration of different charging fee.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a block diagram showing a handsfree apparatus according to an embodiment of the present disclosure;

FIG. 2 is a flowchart showing a handsfree voice call through a WiFi link;

FIG. 3 is a flowchart showing a handsfree voice call through a Bluetooth link;

FIG. 4 is a sequence diagram showing link switch from the WiFi link to the Bluetooth link;

FIG. 5 is a sequence diagram showing link connection to the Bluetooth link;

FIG. 6 is a sequence diagram showing link switch from the Bluetooth link to the WiFi link;

FIG. 7 is a diagram showing a WiFi to Bluetooth switch inquiry window;

FIG. 8 is a diagram showing a Bluetooth connection inquiry window; and

FIG. 9 is a diagram showing a Bluetooth to WiFi switch inquiry window.

### DETAILED DESCRIPTION

An embodiment of the present disclosure will be described with reference to the drawings. In the present embodiment, a mobile phone having Bluetooth communication function is brought in a subject vehicle where a handsfree apparatus is mounted. The handsfree apparatus has wireless fidelity (hereafter referred to as WiFi, which is a registered trademark) communication function and Bluetooth communication function. Additionally, both the handsfree apparatus and the mobile phone are ready for the Bluetooth communication in the vehicle. In this embodiment, WiFi is a brand name showing a certification of the interoperability between wireless apparatuses using the IEEE 802.11 family of standards (IEEE 802.11a/b/g/n etc.).

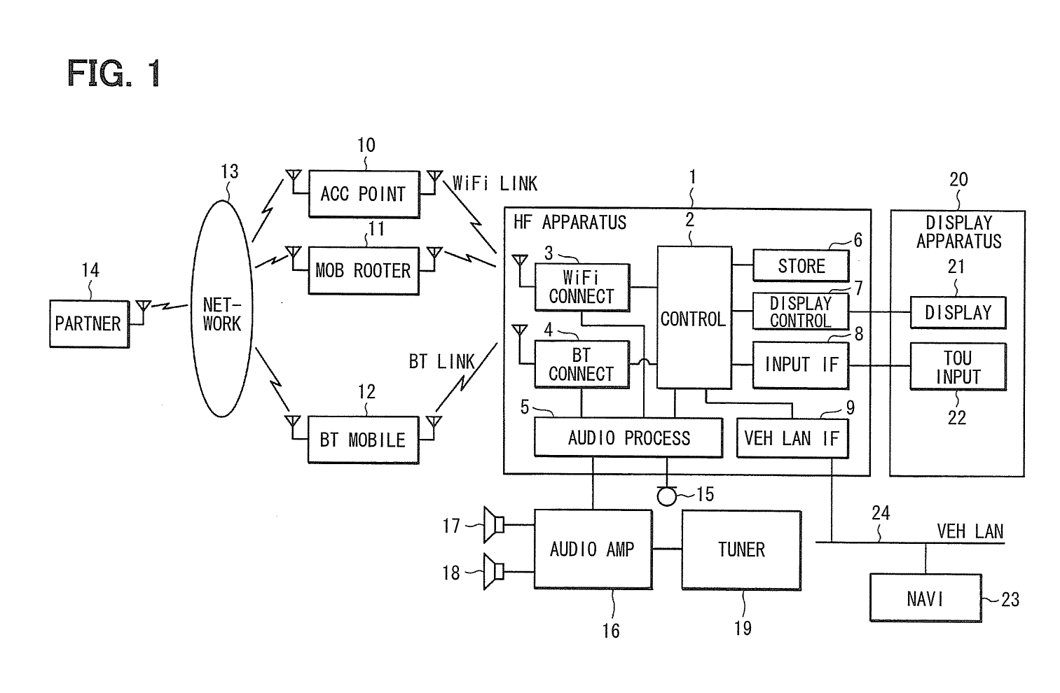

As shown in FIG. 1, a handsfree apparatus 1 includes a handsfree control circuit 2, a WiFi connection portion 3, a BT connection portion 4, a voice call audio process portion 5, a storage portion 6, a display control circuit 7, a touch operation input portion 8, and a vehicle local area network (LAN) interface (IF) portion 9. The handsfree control circuit 2 includes or may function as a connection control section, a radio wave determination section, a disconnection determination section, and a connectibility determination section. The WiFi connection portion 3 may be referred to as a first wireless connection portion, and the BT connection portion 4 may be referred to as a second wireless connection portion.

The handsfree control circuit 2 is a well-known microcomputer having a CPU, a RAM, a ROM, and an input/output bus (also referred to as I/O bus). The handsfree control circuit 2 controls the handsfree apparatus 1 to communicate and manage data and the like. The WiFi connection portion 3 is connectable with an access point 10 and a mobile rooter 11 installed along roads outside the subject vehicle through a WiFi link based on the WiFi communication standards. Each of the access point 10 and the mobile rooter 11 may be referred to as a first connection apparatus. The WiFi link may be referred to as a first short range wireless link. The BT connection portion 4 is connectable with a mobile phone 12, which has Bluetooth communication function and brought in the subject vehicle, through a Bluetooth link based on the Bluetooth communication standards. The Bluetooth link may be referred to as a second short range wireless link. The mobile phone 12 may be referred to as a second connection apparatus. The BT connection portion 4 is further connectable with the mobile phone 12 using a handsfree profile (HFP) defined in the Bluetooth communication standards under a condition that the BT connection portion 4 is connected with the Bluetooth link. The handsfree profile is a profile defined for making a handsfree voice call.

Bluetooth adopts Adaptive Frequency Hopping (AFH) technology, which removes radio frequency interference automatically. Thus, Bluetooth is considered more appropriate than WiFi when used voice call applications which have a high real-time requirement. Further, the BT connection portion 4 may be connectable with the mobile phone 12 using a phone book access profile (PBAP), a message access profile (MAP), and a serial port profile (SPP), to enable exchange of phone book data, exchange of messages, and data transmission, respectively. The above-described profiles may be connected at the same time (multiple connections). Each of the above-described profiles signifies a communication protocol defined by the functions.

The access point 10 or the mobile rooter 11 is connectable with a partner communication apparatus 14, which is the other party of the handsfree apparatus 1 during a handsfree voice call, by connecting (i) a wide area phone link between the access point 10 or the mobile rooter 11, and the communication network 13 and (ii) a wide area phone link between the partner communication apparatus 14 and the communication network 13. Hereinafter, the wide area phone link between the access point 10 and the communication network 13 is also referred to as an access point-network wide area phone link; the wide area phone link between the partner communication apparatus 14 and the communication network 13 is also referred to as a partner-network wide area phone link. Additionally, the mobile phone 12 is connectable with the partner communication apparatus 14 by connecting a wide area phone link between the mobile phone 12 and the communication network 13 and the above partner-network wide area phone link. Hereinafter, the wide area phone link between the mobile phone 12 and the communication network 13 is also referred to as a mobile phone-network wide area phone link. The communication network 13 may include a mobile phone network, a landline phone network, and the internet. The partner communication apparatus 14 is an apparatus having a phoning function, such as a landline phone and a mobile phone.

The voice call audio process portion 5 is connected with a microphone 15, which is installed at a place where voice of a user is collected easily in the subject vehicle, for example, near the steering wheel. The voice call audio process portion 5 is also connected with an audio amplifier 16, which is installed independently with the handsfree apparatus 1. The audio amplifier 16 is connected with two speakers 17 and 18. The audio amplifier 16 is also connected with a tuner deck 19. The tuner deck 19 inputs a music audio signal, which is play backed from a music storage media, and a radio program signal, which is received from the radio broadcasting station, to the audio amplifier 16. The audio amplifier 16 amplifies the inputted signals and outputs the amplified audio signals with the speakers 17 and 18.

The storage portion 6 is configured to store several kinds of data, for example, phone book data, outgoing call log data, and incoming call log data. The phone book data indicates correspondence between phone numbers and registration names. The outgoing call log data indicates correspondence between outgoing call time and outgoing call number of each outgoing call made by the handsfree apparatus 1 or by the mobile phone 12, which is connected with the handsfree apparatus 1 through the handsfree profile. The incoming call log data shows links between incoming call time and incoming call number of each incoming call received by the mobile phone 12, which is connected with the handsfree apparatus 1 through the handsfree profile.

A display apparatus 20 includes a display unit 21 and a touch operation input unit 22. When the handsfree control circuit 2 inputs a display command notification to the display control circuit 7, the display control circuit 7 controls the display unit 21 to display a predetermined image according to the inputted display command notification. When the user operates a touch button shown on a display window, the touch operation input unit 22 inputs an operation detection notification to the touch operation input portion 8. Then, the touch operation input portion 8 transmits the operation detection notification to the handsfree control circuit 2, and the handsfree control circuit 2 analyzes the operation detection notification.

The vehicle LAN IF portion 9 is connected with a navigation system 23 mounted in the subject vehicle through a vehicle LAN 24. The navigation system 23 functions as a well-known navigation system, for example, which can detect a current position of the subject vehicle, read out road map, match the current position of the subject vehicle with the map, set a destination, search for a route from the current position to the destination, guide the subject vehicle along the searched route, and draw the current position and the route on the map.

The mobile phone 12 includes a mobile phone control circuit, a phone communication portion, a BT connection portion, a key input portion, a display portion, a microphone, and a speaker (none shown). The mobile phone is controlled by the control circuit. The phone communication portion performs a phone communication through a mobile phone-network wide area phone link. The BT connection portion performs Bluetooth communication between the mobile phone 12 and the handsfree apparatus 1 through the Bluetooth link. The key input portion is configured by arranging user operational keys. The display portion displays window images. The microphone inputs an audio signal made from voice of the user. The speaker outputs an audio signal received from the partner communication apparatus 14 through the communication network 13 as a received audio signal.

The mobile phone 12 switches the calling mode selectively between a handset calling mode and a handsfree calling mode. When the mobile phone 12 is set to the handset calling mode, the microphone and the speaker of the mobile phone 12 are set to valid. That is, the audio path of the mobile phone 12 is connected. Then, when an audio signal is received from the partner communication apparatus 14 through the partner apparatus-network wide area phone link, and the mobile phone-network wide area phone link, the mobile phone 12 outputs the audio signal with the speaker as the received audio signal. At the same time, the mobile phone 12 also inputs an audio signal from the voice of the user to the microphone, and transmits the audio signal as a transmitted audio signal to the partner communication apparatus 14 through the mobile phone-network wide area phone link, and the partner apparatus-network wide area phone link. When the mobile phone 12 is set to the handsfree calling mode, the microphone and the speaker of the mobile phone 12 are set to invalid. That is, the audio path of the mobile phone 12 is disconnected. Then, when an audio signal is received from the partner communication apparatus 14 through the partner apparatus-network wide area phone link, and the mobile phone-network wide area phone link, the mobile phone 12 transmits the audio signal to the handsfree apparatus 1 through the Bluetooth link, and the handsfree apparatus 1 outputs the audio signal with the speakers 17 and 18 of the handsfree apparatus 1. At the same time, the handsfree apparatus 1 also inputs the audio signal from the voice of the user to the microphone 15 of the handsfree apparatus 1, and transmits the audio signal as the transmitted audio signal to the mobile phone 12 through the Bluetooth link; the mobile phone 12 transmits the transmitted audio signal to the partner communication apparatus 14 through the mobile phone-network wide area phone link, and the partner apparatus-network wide area phone link.

In the above-described configuration, the handsfree control circuit 2 connects the WiFi link between the WiFi connection portion 3 and the access point 10, the mobile rooter 11 in order to make the handsfree voice call through the WiFi link. Further, the handsfree control circuit 2 connects the Bluetooth link between the BT connection portion 4 and the mobile phone 12 in order to make the handsfree voice call through the Bluetooth link.

During a handsfree voice call through the WiFi link, the handsfree control circuit 2 connects the WiFi link between the WiFi connection portion 3 and the access point 10 or the mobile rooter 11; thereby, the audio signal from the partner communication apparatus 14 is transmitted to the WiFi connection portion 3 by the access point 10 and the mobile rooter 11 through the WiFi link. When the audio signal is received, the handsfree control circuit 2 outputs the audio signal to the speakers 17 and 18 of the handsfree apparatus 1 as the received audio signal. At the same time, when the voice of the user is input to the microphone 15 of the handsfree apparatus 1, the handsfree control circuit 2 transmits the audio signal as the transmitted audio signal from the WiFi connection portion 3 to the partner communication apparatus 14 via the access point 10 or the mobile rooter 11 through the WiFi link.

In contrast, during a handsfree voice call through the Bluetooth link, the handsfree control circuit connects the Bluetooth link between the BT connection portion 4 and the mobile phone 12; thereby, the audio signal from the partner communication apparatus 14 is transmitted to the mobile phone 12, and the audio signal is again transmitted to the BT connection portion 4 by the mobile phone 12 through the Bluetooth link and is outputted with the speakers 17 and 18 of the handsfree apparatus 1 as the received audio signal. At the same time, when the voice of the user is input to the microphone 15 of the handsfree apparatus 1, the handsfree control circuit 2 transmits the audio signal as the transmitted audio signal from the BT connection portion 4 to the mobile phone 12 through the Bluetooth link, and the mobile phone 12 transmits the transmitted audio signal to the partner communication apparatus 14. The handsfree voice call based on the WiFi has higher voice quality, higher communication speed performance and lower cost (calling rate) than the handsfree voice call based on the Bluetooth.

The navigation system 23 is configured to read WiFi area map data stored in, for example, a navigation storage portion (not shown). The WiFi area map data is map data, which shows a border between WiFi communicable area and WiFi non-communicable area. The navigation system 23 transmits the WiFi area map data to the handsfree apparatus 1. Specifically, the handsfree control circuit 2 controls the navigation system 23 to transmit current position data of the subject vehicle and the WiFi area map data to the handsfree control circuit 2. Then, the handsfree control circuit 2 compares or collates the current position of the subject vehicle with the WiFi area map according to the current position data of the subject vehicle and the WiFi area map data, and determines whether the WiFi connection portion 3 of the handsfree apparatus 1 is connectable with the access point 10 and the mobile rooter 11 through the WiFi link.

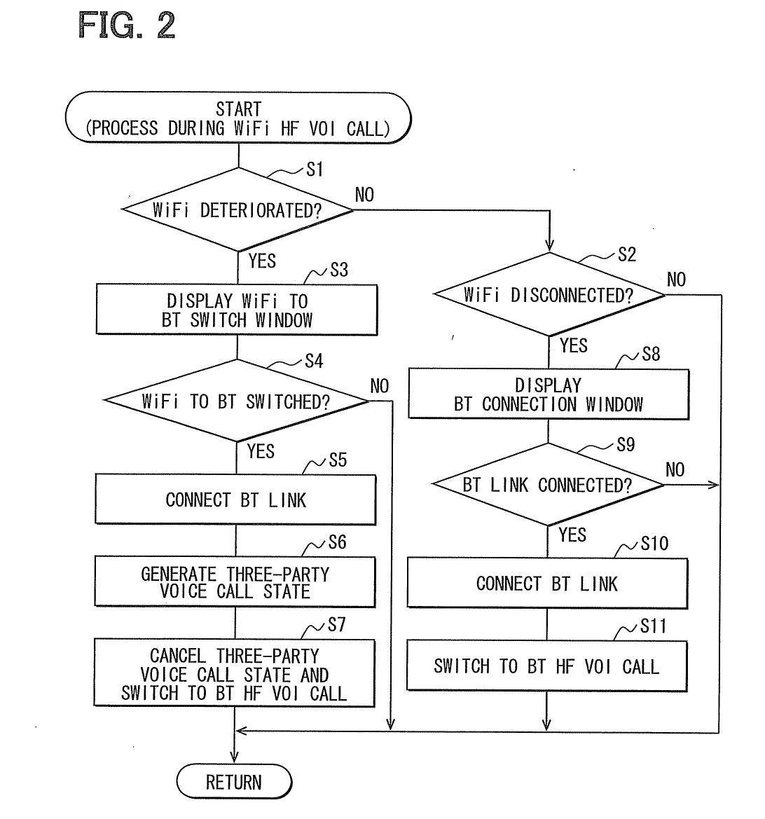

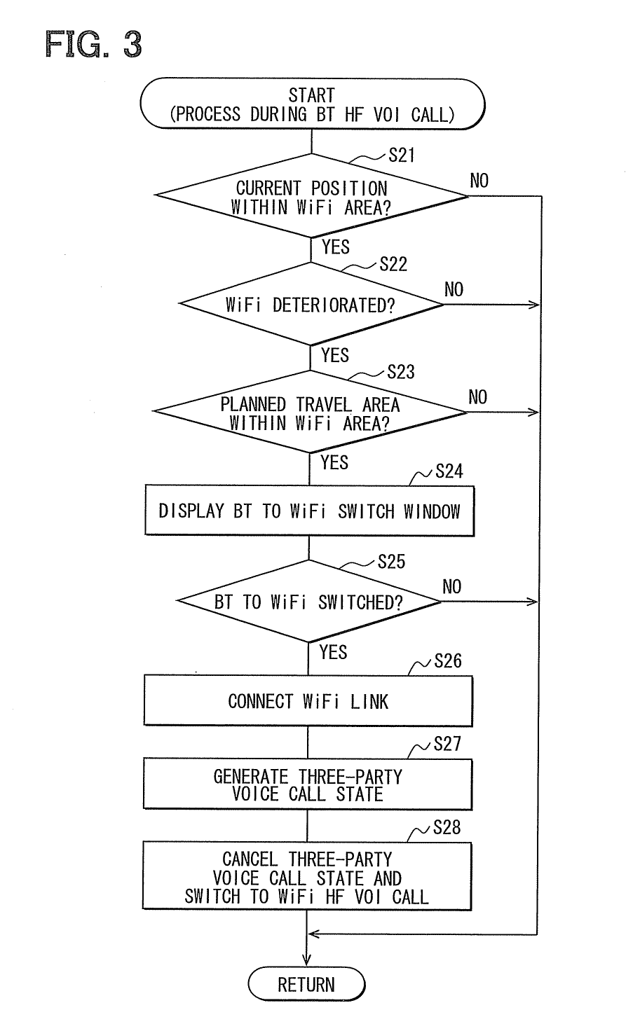

Detailed operations of the above-described configuration will be described with reference to FIGS. 2 to 9. FIG. 2 is a flowchart showing a process executed by the handsfree control circuit 2 during a handsfree voice call based on the WiFi (also referred as WiFi handsfree voice call). FIG. 3 is a flowchart showing a process executed by the handsfree control circuit 2 during a handsfree voice call based on the Bluetooth (also referred as BT handsfree voice call). The following will explain connecting of the WiFi link between the WiFi connection portion 3 and the access point 10. It is noted that connecting of the WiFi link between the WiFi connection portion 3 and the mobile rooter 11 is similar to the connecting of the WiFi link between the WiFi connection portion 3 and the access point 10.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

Each or any combination of sections explained in the above can be achieved as (i) a software section in combination with a hardware unit (e.g., computer) or (ii) a hardware section, including or not including a function of a related apparatus; furthermore, the hardware section may be constructed inside of a microcomputer, and the software section may be included in a software program, which may be contained in a non-transitory computer-readable storage media as a program product.

(1) Process Executed During a WiFi Handsfree Voice Call

During a WiFi handsfree voice call, the handsfree control circuit 2 of the handsfree apparatus 1 connects (i) the WiFi link between the WiFi connection portion 3 and the access point 10, (ii) the access point-network wide area phone link, and (iii) the partner apparatus-network wide area phone link.

When the process executed during a WiFi handsfree voice call starts, the handsfree control circuit 2 determines whether a state of radio waves of the WiFi link is deteriorated (S1), and further determines whether the WiFi link between the WiFi connection portion 3 and the access point 10 is disconnected independently of intention of the user (S2), for example, interruption. Hereafter, a state in which radio waves of the WiFi link is deteriorated (for example, voice quality and communication speed are deteriorated) is also referred to as a first predetermined state. Specifically, as a method of determining whether the state of the radio waves of the WiFi link is deteriorated, for example, the handsfree control circuit 2 may determine whether a received signal strength indicator (RSSI) and a bit error rate (BER) of the radio waves, which are transmitted from the access point 10 and received by the WiFi connection portion 3 through the WiFi link, are less than a predetermined RSSI value and a predetermined BER value, respectively. Alternatively, as a method of determining whether the state of the radio waves of the WiFi link is deteriorated, the handsfree control circuit 2 may also determine whether the received signal strength indicator (RSSI) and the bit error rate (BER) of the radio waves, which are transmitted from the access point 10 and received by the WiFi connection portion 3 through the WiFi link, are less than a RSSI and a BER of the radio waves, which are transmitted from the mobile phone 12 and received by the BT connection portion 4 through the Bluetooth link, respectively. That is, the handsfree control circuit 2 determines whether the state of the radio waves of the WiFi link is deteriorated in an absolute manner or in a relative manner.

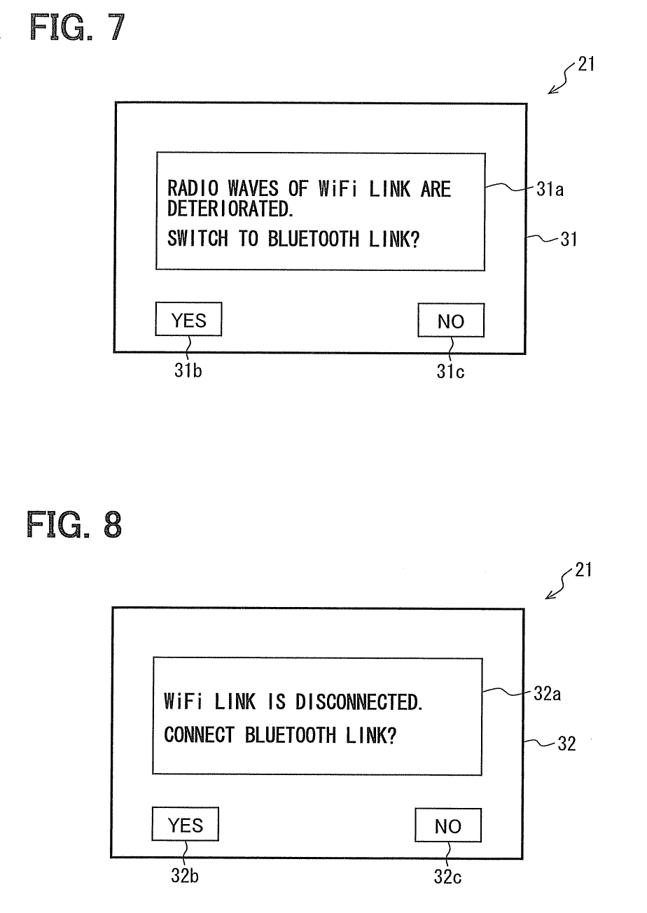

When the handsfree control circuit 2 determines that the state of the radio waves of the WiFi link is deteriorated (S1: “YES”), the handsfree control circuit 2 transmits a display command notification to the display control circuit 7 to display a WiFi to Bluetooth switch inquiry window 31 on the display unit 21 as shown in FIG. 7 (S3); thereby the user can select whether or not to continue the handsfree voice call by switching from the WiFi link to the Bluetooth link (S4). As described above, when the handsfree control circuit 2 determines that the RSSI and the BER of the radio waves, which are transmitted from the access point 10 and received by the WiFi connection portion 3 through the WiFi link, are less than the predetermined RSSI value and the predetermined BER value, or determines that the RSSI and the BER of the radio waves, which are transmitted from the access point 10 and received by the WiFi connection portion 3 through the WiFi link, are less than the RSSI and the BER of the radio waves, which are transmitted from the mobile phone 12 and received by the BT connection portion 4 through the Bluetooth link, the handsfree control circuit 2 determines that the state of the radio waves of the WiFi link is deteriorated. The WiFi to Bluetooth switch inquiry window 31 shown at S3 may include an inquiry message 31a, a “YES” button 31b and a “NO” button 31c. The inquiry message 31a may be set to, for example, “Radio waves of WiFi link are deteriorated. Switch to Bluetooth link?” When the user is inquired, (i) in a case where the user wants to switch from the WiFi link to the Bluetooth link, the user operates the “YES” button 31b; (ii) in a case where the user does not want to switch from the WiFi link to the Bluetooth link, the user operates the “NO” button 31c.

The handsfree control circuit 2 is configured to receive an operation detection notification from the touch operation input portion 8 when the button 31b or 31c on the WiFi to Bluetooth switch inquiry window 31 is operated, and determines which button is operated according to the operation detection notification. When the handsfree control circuit 2 determines the “YES” button 31b is operated on the WiFi to Bluetooth switch inquiry window 31 (S4: “YES”), the handsfree control circuit 2 transmits a connection command notification, which is an AT command defined according to the Bluetooth communication standards, to the access point 10 via the WiFi connection portion 3 so that a call, which is originated from the access point 10 and is destined to the mobile phone 12, is made via the communication network 13.

When the mobile phone 12 receives an incoming call from the access point 10 and the handsfree control circuit 2 determines that the BT connection portion 4 receives an incoming call notification corresponding to the incoming call from the access point 10, the handsfree control circuit 2 connects the Bluetooth link between the BT connection portion 4 and the mobile phone 12 (S5). Then, the handsfree control circuit 2 starts the handsfree voice call through the Bluetooth link by connecting the mobile phone-network wide area phone link between the mobile phone 12 and the communication network 13. At this time, the access point 10 and the partner communication apparatus 14 are in the voice calling state, and the mobile phone 12 and the partner communication apparatus 14 are also in the voice calling state. That is, three-party voice calling state in which the access point 10, the mobile phone 12 and the partner communication apparatus 14 are in the voice calling state via the communication network 13 is generated by the handsfree control circuit 2 (S6).

Thereafter, the handsfree control circuit 2 transmits a disconnection command notification to the access point 10 via the WiFi connection portion 3 so that the WiFi link between the WiFi connection portion 3 and the access point 10 is disconnected; thereby, the three party voice calling state is canceled. The handsfree voice call through the Bluetooth link is continued, and finally, the WiFi handsfree voice call is switched to the BT handsfree voice call (S7).

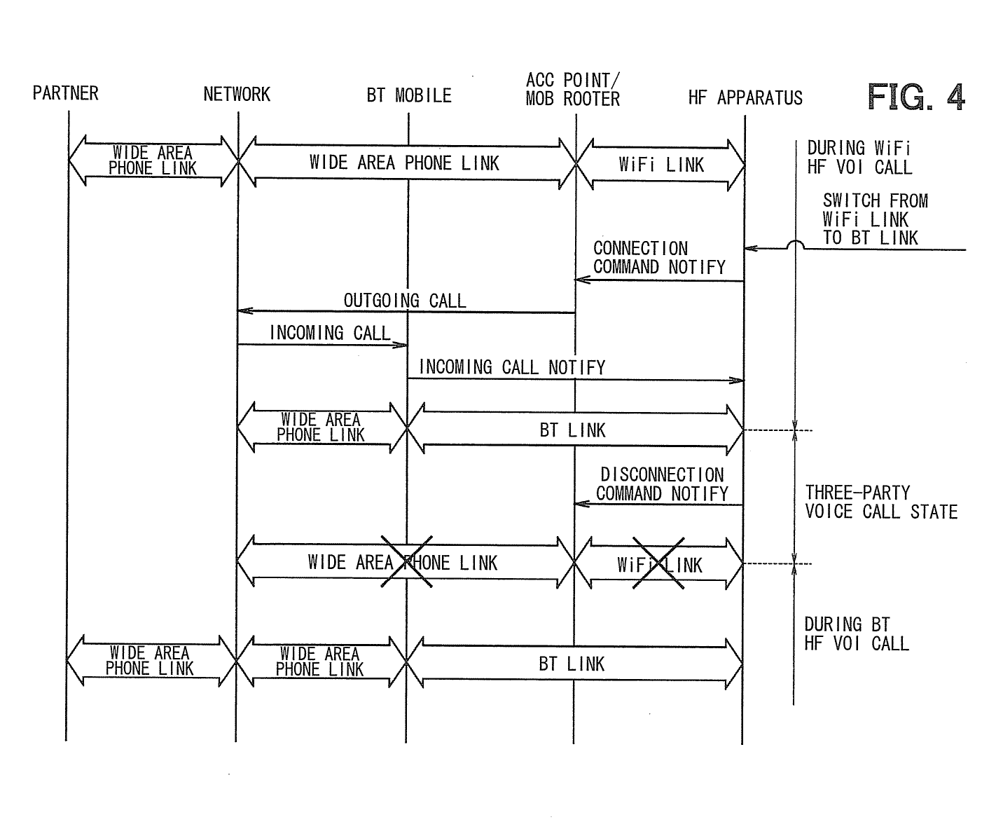

As shown in FIG. 4, when the user selects a switchover from the WiFi link to the Bluetooth link, the handsfree control circuit 2 starts the handsfree voice call through the Bluetooth link before ending the handsfree voice call through the WiFi link. That is, the handsfree control circuit 2 generates the three party voice call state temporarily before ending the handsfree voice call through the WiFi link. Therefore, the handsfree voice call between the handsfree apparatus 1 and the partner communication apparatus 14 continues without interruption (restart after disconnection). Thus, the user can continue the handsfree voice call with the partner communication apparatus 14 with the BT handsfree voice call, although the BT handsfree voice call has a lower calling quality than the WiFi handsfree voice call.

Further, when the handsfree control circuit 2 determines that the WiFi link between the WiFi connection portion 3 and the access point 10 is disconnected (S2: “YES”), the handsfree control circuit 2 transmits a display command notification to the display control circuit 7 to display a Bluetooth connection inquiry window 32 on the display unit 21 as shown in FIG. 8 (S8); thereby, the user can select whether or not to restart the handsfree voice call by connecting the Bluetooth link (S9). The Bluetooth connection inquiry window 32 shown at S8 may include an inquiry message 32a, a “YES” button 32b and a “NO” button 32c. The inquiry message 32a may be set to, for example, “WiFi link is disconnected. Connect Bluetooth link?” When the user is inquired, (i) in a case where the user wants to restart the handsfree voice call, the user operates the “YES” button 32b; (ii) in a case where the user does not want to restart the handsfree voice call, the user operates the “NO” button 32c.

The handsfree control circuit 2 is configured to receive an operation detection notification from the touch operation input portion 8 when the button 32b or 32c on Bluetooth connection inquiry window 32 is operated, and determines which button is operated according to the operation detection notification. When the handsfree control circuit 2 determines the “YES” button 32b is operated on the Bluetooth connection inquiry window 32 (S9: “YES”), the handsfree control circuit 2 transmits a connection command notification, which is an AT command, to the mobile phone 12 via the BT connection portion 4 so that a voice call, which is originated from the mobile phone 12 and is destined to the partner communication apparatus 14, is made via the communication network 13.

When the partner communication apparatus 14 receives the incoming call from the mobile phone 12, the handsfree control circuit 2 connects the handsfree apparatus 1 with the partner communication apparatus 14 by connecting (i) the Bluetooth link between the BT connection portion 4 and the mobile phone 12, (ii) the mobile phone-network wide area phone link, and (iii) the partner apparatus-network wide area phone link. With above-described configuration, the handsfree voice call through the Bluetooth link restarts, that is, the BT handsfree voice call restarts (S11).

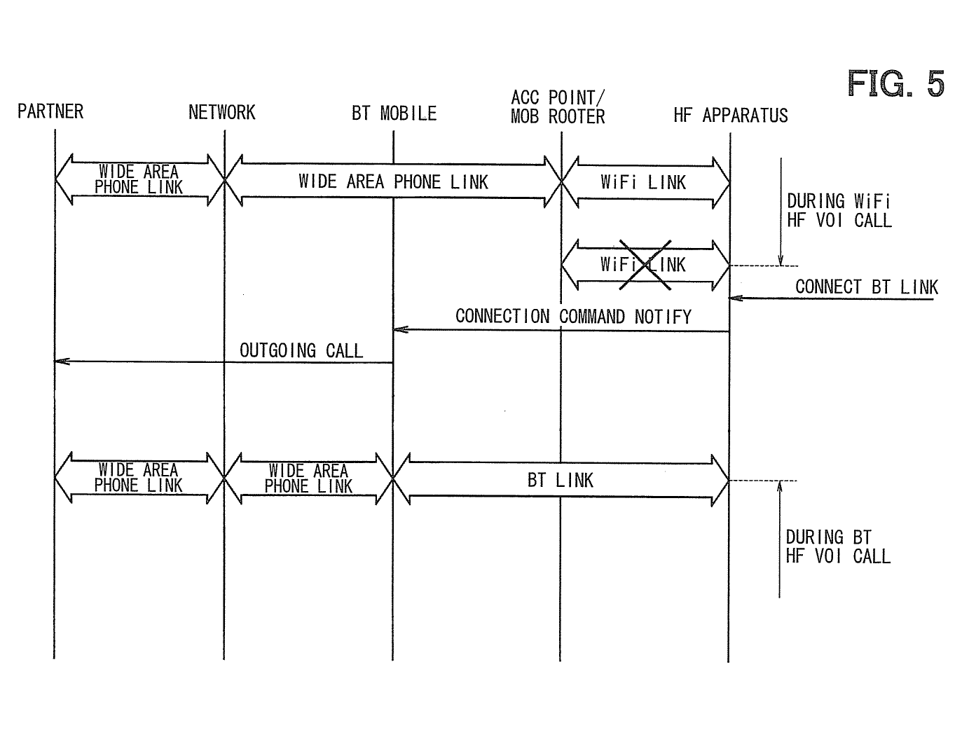

As shown in FIG. 5, when the user selects connecting the Bluetooth link, the handsfree control circuit 2 restarts the handsfree voice call, which is ended, by connecting the Bluetooth link and starting the BT handsfree voice call. Thus, the user can restart the handsfree voice call with the partner communication apparatus 14 with the BT handsfree voice call, although the BT handsfree voice call has a lower calling quality than the WiFi handsfree voice call.

(2) Process Executed During a BT Handsfree Voice Call

During a BT handsfree voice call, the handsfree control circuit 2 of the handsfree apparatus 1 is connecting the Bluetooth link between the BT connection portion 4 and the mobile phone 12, the mobile phone-network wide area phone link, and the partner apparatus-network wide area phone link.

When the process executed during a BT handsfree voice call starts, the handsfree control circuit 2 causes the navigation system 23 to transmit the current position data of the subject vehicle and the WiFi area map data to the handsfree control circuit 2. Then, the handsfree control circuit 2 compares or collates the current position of the subject vehicle with the WiFi area map, and determines whether the current position of the subject vehicle is within the WiFi communicable area (S21).

At S21, when the handsfree control circuit 2 determines that the current position of the subject vehicle is within the WiFi communicable area shown in the WiFi area map (S21: “YES”), the handsfree control circuit 2 further determines whether the state of the radio waves of the WiFi link is improved (S22). Hereafter, a state in which the state of the radio waves of the WiFi link is improved is also referred to as a second predetermined state. Specifically, as a method of determining whether the state of the radio waves of the WiFi link is improved, for example, the handsfree control circuit 2 may determine whether a received signal strength indicator (RSSI) and a bit error rate (BER) of the radio waves, which are transmitted from the access point 10 and received by the WiFi connection portion 3 through the WiFi link, are less than a predetermined RSSI value and a predetermined BER value, respectively. Alternatively, as a method of determining whether the state of the radio waves of the WiFi link is improved, the handsfree control circuit 2 may also determine whether the received signal strength indicator (RSSI) and the bit error rate (BER) of the radio waves, which are transmitted from the access point 10 and received by the WiFi connection portion 3 through the WiFi link, are greater than a RSSI and a BER of the radio waves, which are transmitted from the mobile phone 12 and received by the BT connection portion 4 through the Bluetooth link, respectively. That is, the handsfree control circuit 2 determines whether the state of the radio waves of the WiFi link is improved in an absolute manner or in a relative manner.

At S22, when the handsfree control circuit 2 determines the state of the radio waves of the WiFi link is improved (S22: “YES”), the handsfree control circuit 2 controls the navigation system 23 to transmit planned travel route data and the WiFi area map data. Then, the handsfree control circuit 2 matches the planned travel route and the WiFi area map according to the planned travel route data and the WiFi area map data in order to determine whether the planned travel route is within the Win communicable area (S23). As described above, when the handsfree control circuit 2 determines the RSSI and the BER of the radio waves, which are transmitted from the access point 10 and received by the WiFi connection portion 3 through the WiFi link, are equal to or greater than the predetermined RSSI value and the predetermined BER value, or determines the RSSI and the BER of the radio waves, which are transmitted from the access point 10 and received by the WiFi connection portion 3 through the WiFi link, are greater than the RSSI and the BER of the radio waves, which are transmitted from the mobile phone 12 and received by the BT connection portion 4 through the Bluetooth link, the handsfree control circuit 2 determines that the state of the radio waves of the WiFi link is improved.

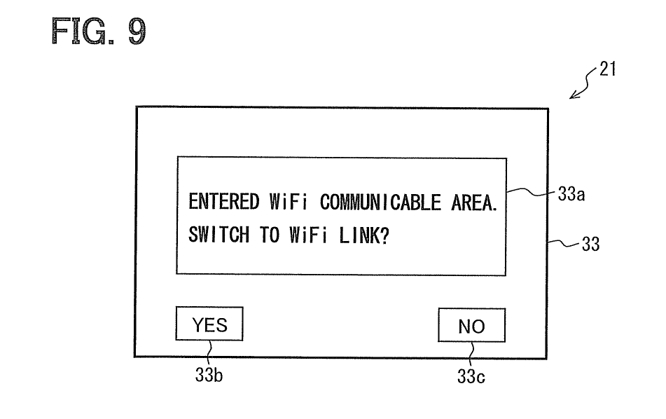

At S23, when the handsfree control circuit 2 determines that the planned travel route is within the WiFi communicable area shown in the WiFi area map (S23: “YES”), the handsfree control circuit 2 transmits a display command notification to the display control circuit 7 to display a Bluetooth to WiFi switch inquiry window 33 on the display unit 21 as shown in FIG. 9 (S24); thereby, the user can select whether or not to continue the handsfree voice call by switching from the Bluetooth link to the WiFi link (S25). The Bluetooth to WiFi switch inquiry window 33 shown at S24 may include an inquiry message 33a, a “YES” button 33b and a “NO” button 33c. The inquiry message 33a may be set to, for example, “Entered WiFi communicable area. Switch to WiFi link?” When the user is inquired, (i) in a case where the user wants to switch from the Bluetooth link to the WiFi link, the user operates the “YES” button 33b; (ii) in a case where the user does not want to switch from the Bluetooth link to the WiFi link, the user operates the “NO” button 33c.

The handsfree control circuit 2 is configured to receive an operation detection notification from the touch operation input portion 8 when the button 33b or 33c on the Bluetooth to WiFi switch inquiry window 33 is operated, and determines which button is operated according to the operation detection notification. When the handsfree control circuit 2 determines the “YES” button 33b is operated on the Bluetooth to WiFi switch inquiry window 33 (S25: “YES”), the handsfree control circuit 2 transmits a connection command notification to the mobile phone 12 via the BT connection portion 4 that a voice call, which is originated from the mobile phone 12 and is destined to the access point 10, is made via the communication network 13.

When the access point 10 receives an incoming call from the mobile phone 12 and the handsfree control circuit 2 determines that the WiFi connection portion 3 receives an incoming call notification corresponding to the incoming call from the mobile phone 12, the handsfree control circuit 2 connects the WiFi link between the WiFi connection portion 3 and the access point 10 (S26). Then, the handsfree control circuit 2 starts the handsfree voice call through the WiFi link by connecting the access point-network wide area phone link between the access point 10 and the communication network 13. At this time, the mobile phone 12 and the partner communication apparatus 14 are in the voice calling state, and the access point 10 and the partner communication apparatus 14 are also in the voice calling state. That is, the three-party voice calling state in which the access point 10, the mobile phone 12 and the partner communication apparatus 14 are in the voice calling state via the communication network 13 is generated by the handsfree control circuit 2 (S27).

Thereafter, the handsfree control circuit 2 transmits a disconnection command notification to the mobile phone 12 via the BT connection portion 4 so that the Bluetooth link between the mobile phone 12 and the BT connection portion 4 is disconnected; thereby, the three party voice calling state is canceled. The handsfree voice call through the WiFi link is continued, and finally, the Bluetooth handsfree voice call is switched to the WiFi handsfree voice call (S28).

When the handsfree control circuit 2 (i) determines the state of the radio waves of the WiFi link is improved (S22: “YES”) and (ii) does not determine the planned travel route is within the WiFi communicable area, that is, the planned travel route is out of the WiFi communicable area (S23: “NO”), the handsfree control circuit 2 continues the BT handsfree voice call without displaying the Bluetooth to WiFi switch inquiry window 33 on the display unit 21.

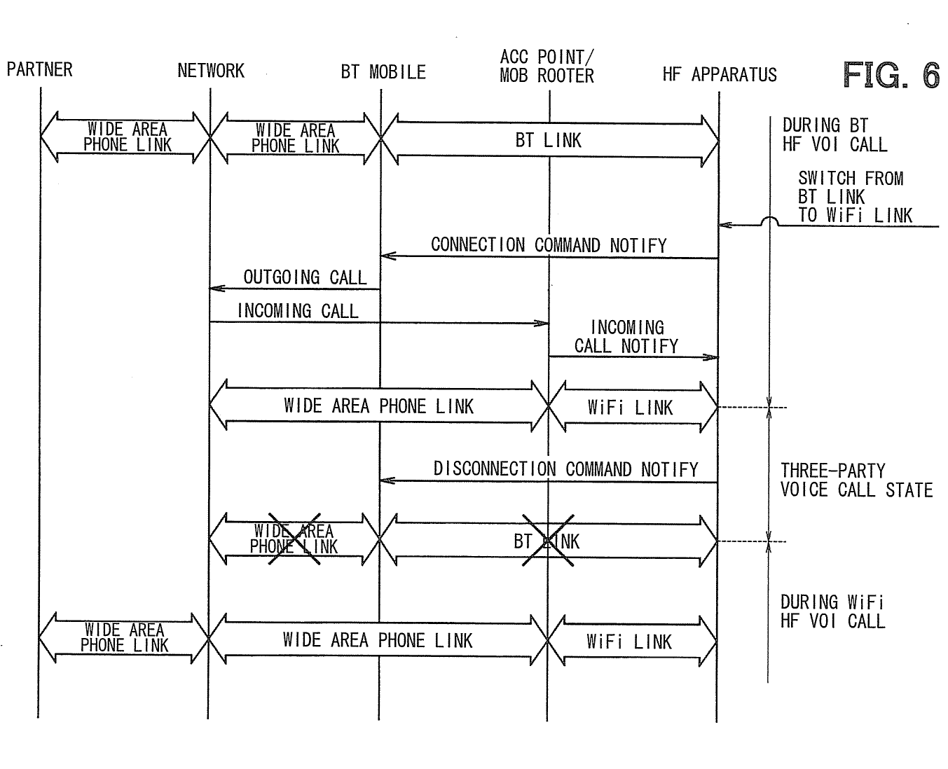

As shown in FIG. 6, when the user selects a switchover from the Bluetooth link to the WiFi link, the handsfree control circuit 2 starts the handsfree voice call through the WiFi link before ending the handsfree voice call through the Bluetooth link. That is, the handsfree control circuit 2 generates the three party voice call state temporarily before ending the handsfree voice call through the Bluetooth link. Therefore, the handsfree voice call between the handsfree apparatus 1 and the partner communication apparatus 14 continues without interruption. Thus, the user can continue the handsfree voice call between the partner communication apparatus 14 through the WiFi handsfree voice call, which has a higher calling quality than the Bluetooth handsfree voice call.

As described above, the handsfree control circuit 2 switches from the WiFi link to the Bluetooth link under a condition that the user selects a continuation of the handsfree voice call by switching from the WiFi link to the Bluetooth link when inquired. The handsfree control circuit 2 also connects the Bluetooth link under a condition that the user selects restarting the handsfree voice call by connecting the Bluetooth link when inquired. The handsfree control circuit 2 also switches from the Bluetooth link to the WiFi link under a condition that the user selects a continuation of the handsfree voice call by switching from the Bluetooth link to the WiFi link when inquired. Alternatively, the handsfree control circuit 2 may be configured to switch from the WiFi link to the Bluetooth link, connect the Bluetooth link or switch from the Bluetooth link to the WiFi link without any condition, for example, without inquiring to the user. Further, the WiFi to Bluetooth switch inquiry window 31, the Bluetooth connection inquiry window 32, the Bluetooth to WiFi switch inquiry window 33 may be displayed on the display unit 21 during a time period when the subject vehicle runs at a speed, which is reduced enough not to affect driving, or during a time period while the subject vehicle waiting at the traffic light. Additionally, the buttons displayed on the above-described windows may be operated during a time period when the subject vehicle runs at a speed, which is reduced enough not to affect driving, or during a time period while the subject vehicle waiting at the traffic light.

As described above, according to the present embodiment, the handsfree apparatus 1 notifies the user when the state of the radio waves of the WiFi link is deteriorated during the WiFi handsfree voice call. When the user selects a switchover from the WiFi link to the Bluetooth link, the handsfree apparatus 1 starts the BT handsfree voice call by connecting the Bluetooth link before ending the WiFi handsfree voice call by disconnecting the WiFi link. Thus, the handsfree voice call between the handsfree apparatus 1 and the partner communication apparatus 14 continues without interruption. Further, in this case, since the user is notified that the state of the radio waves of the WiFi link is deteriorated and inquired whether or not to switch from the WiFi link to the Bluetooth link, the user can select whether or not to continue the handsfree voice call by switching from the WiFi handsfree voice call (WiFi link) to the BT handsfree voice call (Bluetooth link).

By above-described configuration, the user can select continuing the handsfree voice call through the WiFi link whose state of the radio waves is moved to the first predetermined state, or can select continuing the handsfree voice call by switching from the WiFi link to the Bluetooth link. In a case where calling rate or charging fee for handsfree voice call, which is continued through the WiFi link, is different from calling rate or charging fee for handsfree voice call, which is continued by switching from the WiFi link to the Bluetooth link, the user can make a selection in consideration of different calling rates (i.e., selecting a cheaper one).

Further, with the above-described configuration, the handsfree voice call through the WiFi link, which has a higher calling quality than the Bluetooth link, can be continued until the state of the radio waves of the WiFi link is deteriorated, that is, moved to the first predetermined state.

Further, according to the present embodiment, the handsfree apparatus 1 notifies the user when the WiFi link is disconnected during the WiFi handsfree voice call. When the user selects connecting the Bluetooth link, the handsfree apparatus 1 starts the BT handsfree voice call by connecting the Bluetooth link before ending the WiFi handsfree voice call. Thus, the handsfree voice call between the handsfree apparatus 1 and the partner communication apparatus 14 restarts. Further, in this case, since the user is notified that the WiFi link is disconnected and inquired whether or not to connect the Bluetooth link, the user can select whether or not to connect the Bluetooth link in order to restart the handsfree voice call.

By above-described configuration, the user can select ending the handsfree voice call through the WiFi link whose state of the radio waves is deteriorated, or can select restarting the handsfree voice call with the partner communication apparatus 14 by connecting the Bluetooth link between the mobile phone 12 and the handsfree apparatus 1. In a case where the user needs to pay a call charge for handsfree voice call, which is restarted with the partner communication apparatus 14 by connecting the Bluetooth link between the mobile phone 12 and the handsfree apparatus, the user can make a selection in consideration of call charge of the restarted handsfree voice call.

Further, according to the present embodiment, the handsfree apparatus 1 notifies the user when the state of the radio waves of the WiFi link is improved during the Bluetooth handsfree voice call. When the user selects a switchover from the Bluetooth link to the WiFi link, the handsfree apparatus 1 starts the WiFi handsfree voice call by connecting the WiFi link before ending the Bluetooth handsfree voice call by disconnecting the Bluetooth link. Thus, the handsfree voice call between the handsfree apparatus 1 and the partner communication apparatus 14 continues without interruption. Further, in this case, since the user is notified that the state of the radio waves of the WiFi link is improved and inquired whether or not to switch from the Bluetooth link to the WiFi link, the user can select whether or not to continue the handsfree voice call by switching from the Bluetooth handsfree voice call (WiFi link) to the Bluetooth handsfree voice call (Bluetooth link).

By above-described configuration, the user can select continuing the handsfree voice call through the Bluetooth link, or can select continuing the handsfree voice call by switching from the Bluetooth link to the WiFi link whose state of the radio waves is moved to the second predetermined state. In a case where charging fee or call rate for handsfree voice call, which is continued through the Bluetooth link, is different (cheaper or more expensive) from charging fee or call rate for handsfree voice call, which is continued by switching from the Bluetooth link to the WiFi link, the user can make a selection in consideration of different charging fee.

As described above, in a case where the state of the radio waves of the WiFi link, which has a higher calling quality than the Bluetooth link, is moved to the first predetermined state, the handsfree voice call can be continued without interruption by connecting the Bluetooth link, which has a lower calling quality than the WiFi link. Additionally, in a case where (i) the state of the radio waves of the WiFi link is moved to the second predetermined state and (ii) the first connection apparatus is connectable with the handsfree apparatus 1 through the WiFi link, the handsfree voice call can be continued without interruption by connecting the WiFi link, which has a higher calling quality than the Bluetooth link. That is, in a case where the WiFi link, which has a relatively high calling quality, is available, the handsfree voice call having a high calling quality can be provided by connecting the WiFi link as a primary option.

The present disclosure is not limited to the above-described embodiment and configuration. The present disclosure may have various modifications as described above. The handsfree apparatus 1 may have navigation functions as the navigation system 23.

The handsfree apparatus 1 may connect another short range wireless link according to the corresponding communication standard other than the WiFi link and the Bluetooth link. Further, the navigation system 23, instead of the handsfree control circuit 2, may match the current position of the subject vehicle and the planned travel route with the WiFi area map, and transmit the matching result to the handsfree control circuit 2.

The handsfree apparatus 1 may store WiFi relative information of each new road, which is run by the subject vehicle. The WiFi relative information includes a history data which shows whether the corresponding new road is within the WiFi communicable are. According to the WiFi relative information of new roads, the handsfree apparatus 1 may determine whether a planned travel area is within the WiFi communicable area.

As a method of determining whether the planned travel area is within the WiFi communicable area, in a case where (i) one or more consecutive sections of the planned travel route are covered by the WiFi communicable area and (ii) the total distance of the sections is equal to or greater than a predetermined distance, the planned travel area may be determined to be within the WiFi communicable area. In a case where (i) one or more consecutive sections of the planned travel route are covered by the WiFi communicable area and (ii) the total distance of the sections is less than the predetermined distance, the planned travel area may be determined to be out of the WiFi communicable area. With this configuration, a case in which switching again from the WiFi link to the Bluetooth link right after switching from the Bluetooth link to the WiFi link can be restricted. Thus, frequent switch between the Bluetooth link and the WiFi link can be restricted.

Further, when (i) the current position of the subject vehicle is determined to be within the WiFi communicable area and (ii) the state of the radio waves of the WiFi link is improved, the handsfree apparatus 1 may display the Bluetooth to WiFi switch inquiry window 33 on the display unit 21 without determining whether the planned travel are is within the WiFi communicable area.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A handsfree apparatus comprising:
a first wireless connection portion that connects a first short range wireless link with a first connection apparatus, to enable a first handsfree voice call with a partner communication apparatus;
a second wireless connection portion that connects a second short range wireless link with a second connection apparatus, to enable a second handsfree voice call with the partner communication apparatus;
a connection control section that controls connecting and disconnecting of the first short range wireless link, and connecting and disconnecting of the second short range wireless link; and
a radio wave determination section that determines a state of radio waves of the first short range wireless link,
the connection control section being further configured,
in cases that the radio wave determination section determines that the state of the radio waves of the first short range wireless link is moved to a first predetermined state during the first handsfree voice call being executed with the partner communication apparatus through the first short range wireless link,
to start the second handsfree voice call by connecting the second short range wireless link between the second wireless connection portion and the second connection apparatus, and
to then end the first handsfree voice call by disconnecting the first short range wireless link between the first wireless connection portion and the first connection apparatus.

2. The handsfree apparatus according to claim 1, further comprising:
a disconnection determination section that determines whether the first short range wireless link having been connected is disconnected,
wherein, in cases that the disconnection determination section determines that the first short range wireless link is disconnected during the first handsfree voice call being executed with the partner communication apparatus through the first short range wireless link,
the connection control section starts the second handsfree voice call by connecting the second short range wireless link between the second wireless connection portion and the second connection apparatus.

3. The handsfree apparatus according to claim 2, wherein
in cases that the connection control section determines that a user intends to connect the second short range wireless link,
the connection control section starts
the second handsfree voice call by connecting the second short range wireless link between the second wireless connection portion and the second connection apparatus.

4. The handsfree apparatus according to claim 1, further comprising:
a connection possibility determination section that determines whether the first short range wireless link is enabled to be connected between the first wireless connection portion and the first connection apparatus,
wherein, in cases that, during the second handsfree voice call being executed with the partner communication apparatus through the second short range wireless link, (i) the radio wave determination section determines that the state of the radio waves of the first short range wireless link is moved to a second predetermined state and (ii) the connection possibility determination section determines that the first short range wireless link is enabled to be connected between the first wireless connection portion and the first connection apparatus,
the connection control section
starts the first handsfree voice call by connecting the first short range wireless link between the first wireless connection portion and the first connection apparatus, and
then ends the second handsfree voice call by disconnecting the second short range wireless link between the second wireless connection portion and the second connection apparatus.

5. The handsfree apparatus according to claim 4, wherein
in cases that the connection control section determines that a user intends to switch from the second short range wireless link to the first short range wireless link,
the connection control section
starts the first handsfree voice call by connecting the first short range wireless link between the first wireless connection portion and the first connection apparatus and
then ends the second handsfree voice call by disconnecting the second short range wireless link between the second wireless connection portion and the second connection apparatus.

6. The handsfree apparatus according to claim 4, wherein
the connection possibility determination section determines whether the first short range wireless link is enabled to be connected between the first wireless connection portion and the first connection apparatus, according to a comparison result,
the comparison result being obtained by comparing a current position of the handsfree apparatus with a first short range wireless link area map that indicates whether the first short range wireless link is enabled to be connected between the first wireless connection portion and the first connection apparatus.

7. The handsfree apparatus according to claim 1, wherein
in cases that the connection control section determines that a user intends to switch from the first short range wireless link to the second short range wireless link,
the connection control section
starts the second handsfree voice call by connecting the second short range wireless link between the second wireless connection portion and the second connection apparatus, and
then ends the first handsfree voice call by disconnecting the first short range wireless link between the first wireless connection portion and the first connection apparatus.

8. The handsfree apparatus according to claim 1, being placed in a vehicle,
wherein:
the first wireless connection portion is connectable with the first connection apparatus, which is placed external to the vehicle, through the first short range wireless link having a higher calling quality than the second short range wireless link; and
the second wireless connection portion is connectable with the second connection apparatus, which is placed in the vehicle, through the second short range wireless link.

9. A handsfree apparatus comprising:
a first wireless connection portion that connects a first short range wireless link with a first connection apparatus, to enable a first handsfree voice call with a partner communication apparatus;
a second wireless connection portion that connects a second short range wireless link with a second connection apparatus, to enable a second handsfree voice call with the partner communication apparatus;
a connection control section that controls connecting and disconnecting of the first short range wireless link, and connecting and disconnecting of the second short range wireless link; and
a disconnection determination section that determines whether the first short range wireless link having been connected is disconnected,
the connection control section being further configured to start the second handsfree voice call by connecting the second short range wireless link between the second wireless connection portion and the second connection apparatus, in cases that the disconnection determination section determines that the first short range wireless link is disconnected during the first handsfree voice call being executed with the partner communication apparatus through the first short range wireless link.

10. The handsfree apparatus according to claim 9, wherein
in cases that the connection control section determines that a user intends to connect the second short range wireless link,
the connection control section
starts the second handsfree voice call by connecting the second short range wireless link between the second wireless connection portion and the second connection apparatus.

11. The handsfree apparatus according to claim 9, being placed in a vehicle,
wherein:
the first wireless connection portion is connectable with the first connection apparatus, which is placed external to the vehicle, through the first short range wireless link having a higher calling quality than the second short range wireless link; and
the second wireless connection portion is connectable with the second connection apparatus, which is placed in the vehicle, through the second short range wireless link.

12. A handsfree apparatus comprising:
a first wireless connection portion that connects a first short range wireless link with a first connection apparatus, to enable a first handsfree voice call with a partner communication apparatus;
a second wireless connection portion that connects a second short range wireless link with a second connection apparatus, to enable a second handsfree voice call with the partner communication apparatus;
a connection control section that controls connecting and disconnecting of the first short range wireless link, and connecting and disconnecting of the second short range wireless link;
a radio wave determination section that determines a state of radio waves of the first short range wireless link; and
a connection possibility determination section that determines whether the first short range wireless link is enabled to be connected between the first wireless connection portion and the first connection apparatus,
the connection control section being further configured,
in cases that, during the second handsfree voice call being executed with the partner communication apparatus through the second short range wireless link, (i) the radio wave determination section determines that the state of the radio waves of the first short range wireless link is moved to a second predetermined state and (ii) the connection possibility determination section determines that the first short range wireless link is enabled to be connected between the first wireless connection portion and the first connection apparatus,
to start the first handsfree voice call by connecting the first short range wireless link between the first wireless connection portion and the first connection apparatus, and
to then end the second handsfree voice call by disconnecting the second short range wireless link between the second wireless connection portion and the second connection apparatus.

13. The handsfree apparatus according to claim 12, wherein
in cases that the connection control section determines that a user intends to switch from the second short range wireless link to the first short range wireless link,
the connection control section
starts the first handsfree voice call by connecting the first short range wireless link between the first wireless connection portion and the first connection apparatus and
then ends the second handsfree voice call by disconnecting the second short range wireless link between the second wireless connection portion and the second connection apparatus.

14. The handsfree apparatus according to claim 12, wherein
the connection possibility determination section determines whether the first short range wireless link is enabled to be connected between the first wireless connection portion and the first connection apparatus, according to a comparison result,
the comparison result being obtained by comparing a current position of the handsfree apparatus with a first short range wireless link area map that indicates whether the first short range wireless link is enabled to be connected between the first wireless connection portion and the first connection apparatus.

15. The handsfree apparatus according to claim 12, being placed in a vehicle,
wherein:
the first wireless connection portion is connectable with the first connection apparatus, which is placed external to the vehicle, through the first short range wireless link having a higher calling quality than the second short range wireless link; and
the second wireless connection portion is connectable with the second connection apparatus, which is placed in the vehicle, through the second short range wireless link.

16. A handsfree apparatus comprising:
a first wireless connection portion that connects a first short range wireless link with a first connection apparatus, to enable a first handsfree voice call with a partner communication apparatus, the first short range wireless link corresponding to a WiFi link;
a second wireless connection portion that connects a second short range wireless link with a second connection apparatus, to enable a second handsfree voice call with the partner communication apparatus, the second short range wireless link corresponding to a Bluetooth link;
a connection control section that controls connecting and disconnecting of the first short range wireless link, and connecting and disconnecting of the second short range wireless link; and
a radio wave determination section that determines a state of radio waves of the first short range wireless link,
the connection control section being further configured,
in cases that, during the first handsfree voice call being executed with the partner communication apparatus through the WiFi link, (i) the radio wave determination section determines that the state of the radio waves of the WiFi link is moved to a first predetermined state and further (ii) the connection control section determines that a user intends to switch from the WiFi link to the Bluetooth link, the connection control section
to start the second handsfree voice call by connecting the Bluetooth link between the second wireless connection portion and the second connection apparatus, and
to then end the first handsfree voice call by disconnecting the WiFi link between the first wireless connection portion and the first connection apparatus.
